(19) United States
(12) Patent Application Publication
(10) Pub. No.: US 2026/0203795 A1
(43) Pub. Date: Jul. 16, 2026

(54) PRODUCT EXPERIENCE DEVICE AND PROGRAM THAT EXECUTES SAME

(71) Applicant: ALICE STYLE, INC., Tokyo (JP)

(72) Inventor: Rieko MURAMOTO, Tokyo (JP)

(73) Assignee: ALICE STYLE, INC., Tokyo (JP)

(21) Appl. No.: 19/138,073

(22) PCT Filed: Dec. 13, 2023
(86) PCT No.: PCT/JP2023/044713

§ 371 Date: Jun. 11, 2025

(30) Foreign Application Priority Data
Dec. 13, 2022 (JP) 2022-198682

(51) Int. Cl. G06Q 30/0282

(52) U.S. Cl. CPC G06Q 30/0282

(57) ABSTRACT

A product experience providing device includes a storage unit that stores a product object in a virtual space, which corresponds to a product present in a real space, product information, and owner information approved as an owner of at least any one of the product object or the product, an object providing unit that provides the product object and a user object such that the product object and the user object are displayable on a user terminal, a product experience providing unit that provides the product object such that the product object is usable in a virtual space accessible by the user terminal in a case where a request related to at least any one of the product object or the product is made from the user terminal, and a product object rewarding unit that provides a predetermined reward to the owner according to the request within a predetermined period.

### TECHNICAL FIELD

The present invention relates to a product experience device and a program for implementing the product experience device.

### BACKGROUND ART

Conventionally, there have been proposed a system (Patent Literature 1) that displays an advertisement using a virtual space, posts a link for the advertisement, and guides a customer to a coupon or a purchase site, and a system (Patent Literature 2) that provides a shopping experience in a distant store such as overseas or a virtual space in association with actual map information.

### CITATION LIST

### Patent Literature

PATENT LITERATURE 1: JP-A-2022-144468

PATENT LITERATURE 2: JP-A-2007-226614

### SUMMARY OF INVENTION

### Problems to be Solved by Invention

However, in any of the above-described conventional technologies, although the product is displayed as the virtual reality video for the customer who experiences the virtual space, the usability and evaluation of the product cannot be actually checked or shared in the virtual space. Therefore, these technologies still remain the same as an EC site two-dimensionally developed on the Web for checking the performance of the product. For this reason, even if various people virtually view products displayed as virtual reality videos, it has been difficult to increase appeal to the customers about the target products. In addition, the services as described above are utilized as one of channels through which stores and companies mainly sell their own products. However, there is no sales channel utilizing such a mechanism even in exchange of goods between individuals. Furthermore, in a virtual world space, trade of goods on a virtual space has been performed using communication by an avatar while viewing a 3D image or a moving image, but there has been no mechanism to associate the trade with an actual product and transfer the product.

The present invention has been made in view of such circumstances, and an object of the present invention is to provide a product experience device capable of enhancing convenience for a customer who intends to experience and trade a virtual product by viewing a virtual reality video of a target product, and a program for implementing the product experience device.

### Solution to Problems

The product experience device, a product experience method, and a program according to the present invention adopt the following configurations.
(1): A product experience providing device includes
a storage unit that stores a virtual space built on the Internet, a product object in the virtual space, which corresponds to a product present in a real space, product information associated with information (product object information) on the product object, and owner information approved as an owner of the product object and the product or any one of the product object or the product,
an object providing unit that provides the product object and a user object in the virtual space such that the product object and the user object are displayable on a display unit of a user terminal in the real space in association with the user terminal,
a product experience providing unit that provides the product object such that the product object is usable in a virtual space accessible by the user terminal in a case where a request related to the product object and the product or any one of the product object or the product is made from the user terminal in the real space, and
a product object rewarding unit that provides a predetermined reward to the owner of the product object and the product corresponding thereto according to a user's request from the user terminal within a predetermined period.
(2): The product experience providing device according to (1) further includes
a product and product object price determination unit that
transacts a right related to the owner of the product object and the product or any one of the product object or the product on a predetermined transaction platform, and
in transaction, determines a transaction price of the product object and the product or any one of the product object or the product based on a price desired by the owner.
(3): In the product experience providing device according to (1),
the right related to the owner of the product object and the product or any one of the product object or the product includes information on a second owner to whom the owner lends the right, and
the product experience providing device further includes a share giving unit that gives, to the owner, part of an economic profit obtained by the second owner from the product object and the product or any one of the product object or the product.
(4): The product experience providing device according to (1) further includes
a cryptocurrency providing unit that in a case where there is the request related to the product object and the product or any one of the product object or the product from the user terminal, provides a cryptocurrency corresponding to the product object and the product or any one of the product object or the product such that the cryptocurrency is usable in the user terminal.
(5): In the product experience providing device according to (4),
the cryptocurrency is a token issued using a predetermined distributed ledger technology.
(6): In the product experience providing device according to (1),
the owner of the product object and the product or any one of the product object or the product is certified by a non-fungible token, and
when the certified owner is changed, information is updated in the storage unit with the owner information and information on the product object and the product or any one of the product object or the product associated with information on the changed owner.
(7): A product experience providing method includes
a step of acquiring, from a product experience providing device, a virtual space built on the Internet, a product object corresponding to a product present in a real space, product information associated with information (product object information) on the product object, and owner information approved as an owner of the product object and the product or any one of the product object or the product,
a step of displaying, on a display unit, the virtual space, the product object, and a user object according to a request from the user terminal,
a step of causing the product object to be usable by the user terminal in a case where a request related to the product object and the product or any one of the product object or the product is made from the user terminal in a real space, and
a step of providing a predetermined reward to the owner of the product object and the product corresponding thereto according to a request from the user terminal within a predetermined period.
(8): A product experience providing program causes a computer to function as
a storage unit that stores a virtual space built on the Internet, a product object in the virtual space, which corresponds to a product present in a real space, product information associated with information (product object information) on the product object, and owner information approved as an owner of the product object and the product or any one of the product object or the product,
an object providing unit that provides the product object and a user object in the virtual space such that the product object and the user object are displayable on a display unit of a user terminal in the real space in association with the user terminal,
a product experience providing unit that provides the product object such that the product object is usable in a virtual space accessible by the user terminal in a case where a request related to the product object and the product or any one of the product object or the product is made from the user terminal in the real space, and
a product object rewarding unit that provides a predetermined reward to the owner of the product object and the product corresponding thereto according to a user's request from the user terminal within a predetermined period.
(9): A product experience providing system includes a product experience providing device and a user terminal. The product experience providing device includes
a storage unit that stores a virtual space built on the Internet, a product object in the virtual space, which is present in a real space and corresponds to a real product, product information associated with information (product object information) on the product object, and owner information approved as an owner of the product object and the product or any one of the product object or the product,
an object providing unit that provides the product object and a user object in the virtual space such that the product object and the user object are displayable on a display unit of the user terminal in a real space in association with the user terminal,
a product experience providing unit that provides the product object such that the product object is usable in a virtual space accessible by the user terminal in a case where a request related to the product object and the product or any one of the product object or the product is made from the user terminal in the real space, and
a product object rewarding unit that provides a predetermined reward to the owner of the product object and the product corresponding thereto according to a user's request from the user terminal within a predetermined period. When the user terminal transmits the request related to the product object and the product or any one of the product object or the product to the product experience providing device in the real space, the product experience providing device provides the product object related to the request such that the product object are usable in the user terminal, and the product experience providing device provides the predetermined reward to the owner of the product object and the product or any one of the product object or the product according to the request from the user terminal within the predetermined period.

### Effects of Invention

According to (1) to (9), convenience to the customer who views the virtual reality video and experiences and trades the virtual reality product of the target product can be enhanced. In addition, it is possible to provide a device that facilitates the trade of the product in virtual reality.

### BRIEF DESCRIPTION OF THE DRAWINGS

FIG. 1 is a diagram showing an example of the configuration of a product experience system 1 according to the present invention.

FIG. 2 is a diagram showing an example of the outline of the product experience system 1 according to the present invention.

FIG. 3 is an example of a hardware configuration of a product experience providing device according to the present invention.

FIG. 4 is an example of hardware configurations of a user terminal and an owner terminal according to the present invention.

FIG. 5 is a functional block diagram of the product experience providing device according to the present invention.

FIG. 6 is a diagram schematically showing an example of a data structure in a storage unit of the product experience providing device according to the present invention.

FIG. 7 is a chart schematically showing a representative processing process performed between terminals of the product experience providing device according to the present invention.

FIG. 8 is a functional block diagram partially showing a modification of the product experience providing device according to the present invention.

FIG. 9 is a functional block diagram partially showing another modification of the product experience providing device according to the present invention.

FIG. 10 is a functional block diagram partially showing still another modification of the product experience providing device according to the present invention.

FIG. 11 is a functional block diagram partially showing still another modification of the product experience providing device according to the present invention.

FIG. 12 is a chart schematically showing an example of processing for describing a change in an owner in the product experience providing device according to the present invention.

### DESCRIPTION OF EMBODIMENTS

Hereinafter, embodiments of a product experience device, a product experience method, and a program of the present invention will be described with reference to the drawings. A product experience system including the product experience device of the present invention is, for example, a system that uses the product experience device to provide virtual product experience and trade such as a virtual travel experience while using a virtual product experience and trade facility. The product experience device of the present invention provides a customer with a service for experiencing and trading a virtual product in a real world or a space virtually representing a virtual world. In the product experience system of the present invention, in addition to the virtual travel experience, it is possible to provide virtual product experience and trade, for example, virtual product experience and trade in an unrealistic game world or the like.

In the present invention, the “virtual space” indicates a virtual space built on a computer or a network. In particular, in the present invention, the virtual space means a place where people have an interaction or perform a social activity on a network as in a real world. In the present invention, in a case where customers interact with each other on a network, the customers can interact with each other as characters which are virtual images representing themselves, i.e., avatars. Although the type of such a virtual space is not particularly important in the present invention, the virtual space may be one imitating the current real space, or may be a mixture thereof. Furthermore, a space which cannot exist in a real world may be built, and customers may interact with each other in such a space.

In the present invention, a “product object” means a digitally-built object used as an avatar by the customer in the virtual space. In the present specification, information for building such an object will be referred to as “product object information”. In an embodiment of the present invention, the product object faithfully imitates a product in the real world. That is, in the virtual space, the customer (or an owner as an avatar in the virtual space) can demonstrate the product using the product in the same manner as that in the real world, and check actual size and state.

In the present invention, product information indicates product information in the real world. The “product information” is stored in a storage unit of the present invention in association with the “product object information”.

The storage unit in a product experience providing device of the present invention is present on a local or cloud server. The storage unit stores virtual space building information for building the virtual space, the product object information in the virtual space, which corresponds to the product present in the real world, the product information associated with the product object information, and owner information approved as the owner of the product object and the product.

An object providing unit of the present invention displays the product object on a terminal of the customer (owner) in the current real space with the product object in the virtual space and the customer as the avatar associated with each other, or on the terminal of the customer (or terminals of the customer and a user) with the customer and the owner of the product object associated with each other. Examples of the terminal on which the product object is displayed include a mobile phone, a desktop computer, and a notebook computer. The terminal may be a goggle-type headset physically connected to the terminal or connected to the terminal via the Internet, a controller used in combination with the goggle-type headset as necessary, or one equivalent thereto.

For the product object and the product or any one of the product object or the product, in a case where there is an application for any one of or a combination of use in the virtual space, transfer in the virtual space, rental in the virtual space, rental in the real world, and transfer in the real world from the customer terminal in the current real space, a “product experience providing unit” in the present invention first displays the product object in the virtual space, and then executes an operation in response to the application

In the case of the use in the virtual space, the user's avatar can temporarily pass the product object to the customer's avatar in the virtual space, or the user's avatar can demonstrate the product object in front of the customer's avatar. When the use ends, the avatar holding the product object returns the product object.

In the case of the rental or the transfer in the virtual space, a rental period for the customer's avatar starts after the product object has been passed to the customer's avatar in the virtual space. In the present invention, an object rewarding unit described below can generate a reward for the entirety or part of the rental period. Such processing can be performed in the product object rewarding unit according to the present invention, and specifically, can be executed by an NFT management unit in the server.

Subsequent to or independently of the event in the virtual space as described above, the product in the real world, which corresponds to the product object browsed by the customer in the virtual space can be transferred or rented from the owner to the customer in the real world by the customer performing a request operation with the customer terminal. In such processing, the price and/or rental cost for the product can be processed at a reward settlement unit in the server. Alternatively, the processing can be executed in a product and product object rewarding unit according to the present invention by the NFT management unit in the server.

The product experience providing device of the present invention includes the product and product object rewarding unit that provides a predetermined reward to the owner of the product object and the corresponding product according to the number of requests from the user terminal within a predetermined period.

In another embodiment of the present invention, in the product experience providing device, the right of the owner regarding the product object and the product is processed on a predetermined transaction platform. In other words, the processing is executed in a server of a predetermined platformer. Here, a product object price determination unit that sets the transaction price for the product object and the product based on a price desired by the owner is provided.

In another embodiment of the present invention, in the product experience providing device, the right of the owner regarding the product object includes information on a second owner to whom the owner has transferred the right. The product experience providing device further includes a share giving unit that gives part of an economic profit obtained by the second owner from the product object and the product or any one of the product object or the product to the owner. Such processing can be executed in the server of the platformer.

In another embodiment of the present invention, the product experience providing device further includes a cryptocurrency providing unit that in a case where there is a request related to the product object and the product or any one of the product object or the product from the user terminal, provides a cryptocurrency corresponding to the product object so that the cryptocurrency can be used in the user terminal. Such processing can be performed in conjunction with the server of the platformer or a server operated by a cryptocurrency trading company and the rewarding unit provided in the server of the platformer. In addition, the cryptocurrency handled in the product experience providing device is a token issued using a predetermined distributed ledger technology. In such an aspect, the token is a non-fungible token, and the owner of the product object and the product or any one of the product object or the product is certified by the non-fungible token, and when the certified owner is changed, the information is updated in association with the owner information, the information on the product object and the product or any one of the product object or the product, and the changed information in the storage unit according to the present invention.

The present invention also includes a method for implementing the product experience providing device described above and/or a program for executing various types of processing in the product experience providing device, and a system for implementing this device.

An embodiment of the present invention will be described with reference to the drawings.

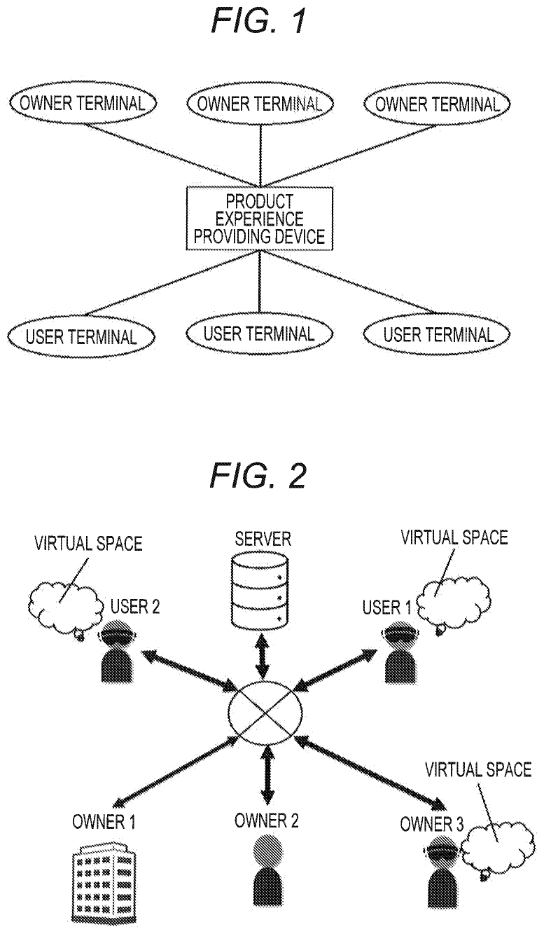

As shown in FIG. 1, a product experience providing system (hereinafter, referred to as the “present system”) according to the embodiment of the present invention includes a product experience providing device user terminals, and owner terminals. The product experience providing device, the user terminal, and the owner terminal are communicably connected to each other via a network.

The product experience providing device of the present system includes a recording medium capable of reading a product experience providing program. Such a medium may be a server existing locally, or may be a server existing on the cloud. The program for implementing the product experience providing device is read by a processor (control unit) in the product experience providing device, and physically and/or logically cooperates with a hardware resource to implement the product experience providing system and a product experience providing method.

In the present system, the user can experience the virtual space using the user terminal. That is, as shown in FIG. 2, a user 1 and a user 2 can view the same virtual space with a headset or the like. In the virtual space, the user 1 and the user 2 can also browse and request a product object put up for sale by an owner 1, an owner 2, or an owner 3 to experience as if the product object is actually used in the current real space. In order to provide such an experience, a database 2 in the product experience providing device according to the present invention includes a product icon database. The product icon database is objectized based on the product in the real space, and performs the processing based on the product information provided from the user so that the user can experience the operation and size of the product in the virtual space.

In the present invention, the user 1 and the user 2 can experience the same product or different products in the same virtual space, or can experience different products or the same product in different virtual spaces. Further, as described in detail below, the user 1 can be the owner of the product object created by the product icon database stored in the product experience providing device of the present invention. Such ownership can be transferred. Therefore, the product object can be transferred to the owner 2, the owner 3, and the like in the same manner as that in the real world.

Furthermore, in the present invention, the database in the product experience providing device of the present invention stores information on a real product in association with the product object information, and the product in the real space can be rented or sold to the user in response to a user's request.

That is, the user can be the owner of the product object in the present invention or the product corresponding to the product object in the real space. The owner can exchange information on the owned product object in response to the request of the user in the same virtual space as that for the user. The user can rent the product object from the owner for a certain period of time. During this time, the user can determine whether to rent or purchase the corresponding real product based on the information from the product object.

The user can use the product experience providing system using the user terminal. A hardware configuration of the user terminal will be described later. On a display unit (display or the like) of the user terminal, the product object and the user's avatar in the virtual space 1 shown in FIG. 2 are displayed as 3D objects or 3D images (not shown).

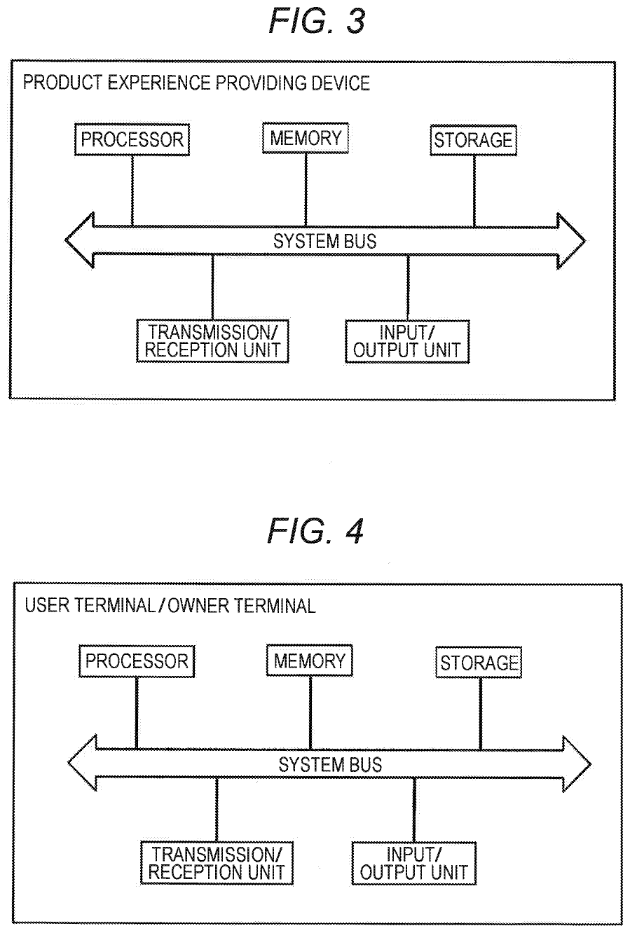

FIG. 3 is a diagram showing a hardware configuration example of the product experience providing device. The shown configuration is an example, and may have other configurations and may be replaced with elements having similar functions. Furthermore, although the product experience providing device is shown as one device, a plurality of devices may be combined into one device.

As shown in FIG. 3, the product experience providing device is a type of information processing device. The product experience providing device typically includes a processor, a memory, a storage, a transmission/reception unit, an input/output unit, and a bus.

An example of the processor may be a central processing unit (CPU) or a micro-processing unit (MPU). Furthermore, the processor may include a graphics processing unit (GPU), a digital signal processor (DSP), and the like. That is, the processor may be any device that can execute a certain program command. The processor may include a register, an L1 cache, and an L2 cache that store information at a position physically close to the processor. These components may be included in the processor, but may be included in the memory or the storage.

The memory is a temporary storage, and a random access memory (RAM) can be used. The memory temporarily loads and stores data from the storage.

The storage is a device that records information. This storage may be either an external memory or an internal memory. The storage may be either a main storage or an auxiliary storage. The storage may be a magnetic disk (hard disk), an optical disk, a magnetic tape, a semiconductor memory, or the like. In addition, the storage may include a storage via a network, and a storage on the cloud via a network.

The storage of the present invention may include the product experience providing program according to the product experience providing system of one embodiment. The storage may also record part or the entirety of data necessary for executing the service related to the present invention. In addition, the storage may include a database to be described later.

Regarding the above-described configuration, the case where the processor executes the product experience providing program stored in the storage has been described. However, the processor, the storage, and the bus may be combined to form a dedicated circuit in which information processing to be executed is determined, such as a programmable logic device (PLD).

The transmission/reception unit transmits information together with a communication interface (IF). The transmission/reception unit includes a transmission unit and a reception unit. The transmission/reception unit has a function of transmitting information on the product experience providing device to another information terminal (user terminal or owner terminal) via a network. The communication IF may be in any connection form such as USB, IEEE1394, the Ethernet (registered trademark), PCI, or SCSI. The network may be either wired or wireless, and an optical fiber, a coaxial cable, or the like may be used. The connection according to the system of the one embodiment described above may be direct connection or indirect connection.

The input/output unit includes an input device and an output device. Examples of the input device include a keyboard, a mouse, a touch panel, a pen-type instruction device, and the like. The display device has a function of displaying information. For example, any device capable of displaying information, such as a liquid crystal display, a plasma display, or an organic EL display, may be used. In addition, the input device may be partially provided, such as a touch panel.

Hardware forming the product experience providing device may be a general-purpose electronic computer or a dedicated electronic computer. The hardware may be a workstation, a desktop computer, a laptop computer, a notebook computer, a PDA, a mobile phone, a smartphone, or the like.

In FIG. 3, one product experience providing device has been described, but the product experience providing device may include a plurality of information processing devices. In a case where the plurality of information processing devices is provided, one or more of the information processing devices may be a terminal device. The plurality of information processing devices may be internally connected or externally connected. Furthermore, in a case where the product experience providing device includes the plurality of information processing devices, the owners thereof may be different. In addition, a person who operates a content providing device may be different from the owner of the product experience providing device. In addition, the product experience providing device may be virtual. For example, the product experience providing device may be virtually implemented using cloud computing.

FIG. 4 is a diagram showing a hardware configuration example of the user terminal or the owner terminal connected to the product experience providing device via the network such that the information processing is performed. The shown configuration is an example, and may have other configurations and may be replaced with elements having similar functions. Furthermore, although the user terminal is shown as one device, a plurality of devices may be combined into one device.

Of the following elements, elements with the same names may have configurations similar to those of the product experience providing device described above, and therefore, the detailed description thereof will be omitted.

As shown in FIG. 4, the product experience providing device is a type of information processing device. The product experience providing device typically includes a processor, a memory, a storage, a transmission/reception unit, an input/output unit, a bus.

The user terminal or the owner terminal may optionally include the position information acquiring unit. The position information acquiring unit acquires the current position of the user terminal by a global positioning system (GPS). The position information may be acquired from an IP address or a connected wireless network device. With such a position information acquiring unit, the virtual space according to the present invention can be each surreal virtual space formed by fusing the current real space and the virtual space.

Hardware forming the user terminal and the owner terminal of the present invention may also be a general-purpose electronic computer or a dedicated electronic computer, similarly to the product experience providing device described above. The hardware may be a workstation, a desktop computer, a laptop computer, a notebook computer, a PDA, a mobile phone, a smartphone, or the like. However, since the hardware is desirably carried by the user, these pieces of hardware are preferably portable.

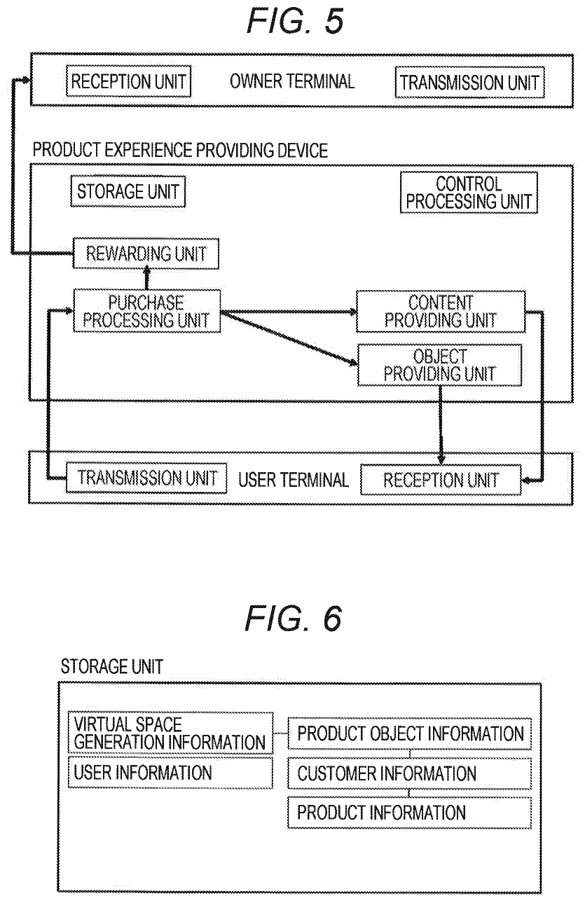

FIG. 5 is a functional block diagram of the product experience providing device. The product experience providing device may have only some of these functions.

The storage unit stores virtual space generation information for generating a virtual space generated based on geographic information on the real space, information for displaying the product object corresponding to the product existing in the real space, the owner information certified as the owner of the product object, and content information associated with the owner information.

When there is the position information acquiring unit, the position information acquiring unit receives the position information on the user terminal, which is transmitted from the user terminal. The position information may be received in response to a request from the product experience providing device, or may be actively transmitted from the user terminal.

The object providing unit displays the virtual space, the product object, a user object, and an owner object as necessary. In the present specification, the user or owner object may be an avatar which is a character in the virtual space.

These objects may be provided so as to be displayable on the display unit of the user terminal in association with the position information on the user terminal in the real space.

A purchase processing unit performs purchase settlement processing when a product object use request, a product object rental request, a product object purchase request, or a product purchase/rental request is received from the user terminal. In the present invention, a payment processing method can be performed by the object rewarding unit.

In a case where the purchase processing is appropriately performed, the product experience providing unit provides the product object provided by the owner of the product object such that the product object is usable by the user terminal. That is, the user can pick up, operate, or try the product object as if the user actually uses the product object in the virtual space in a state in which the user terminal is connected to the Internet.

The rewarding unit gives a predetermined incentive to the owner of the product and/or the product object according to a purchase result or request information on the product object.

As shown in FIG. 6, the product experience providing device includes the virtual space generation information and user information. The virtual space generation information includes at least structure object information, the owner information, and the content information. Note that part of the information provided from an external terminal may be used, and all pieces of information may not be always stored in the storage unit.

The virtual space generation information is information necessary for displaying the virtual space corresponding to the real space on the user terminal. As the virtual space generation information, the structure object information, the owner information, and the content information are used. The virtual space generation information may be data such as a 3D map, a 3D object, an effect, an image, and a text.

The user information is information in which each of the user terminal and the owner terminal using the present system is associated with the user. Typically, the user information may include a user ID, a password, payment information, unique identification information on the terminal, and contact information.

The owner information is information on an owner who owns a structure object., The structure object is traded on a predetermined transaction platform. The product experience providing device maintains and updates the owner information to the latest one.

The content information is content information associated with the owner. Examples of the contents may be an art, a character, a domain name, a music, a video, a picture, a voice, a card, a land of another virtual space, and a point created by the owner. These contents may be managed and held by the owner, or may be certified as being created by the owner and managed or owned by another user.

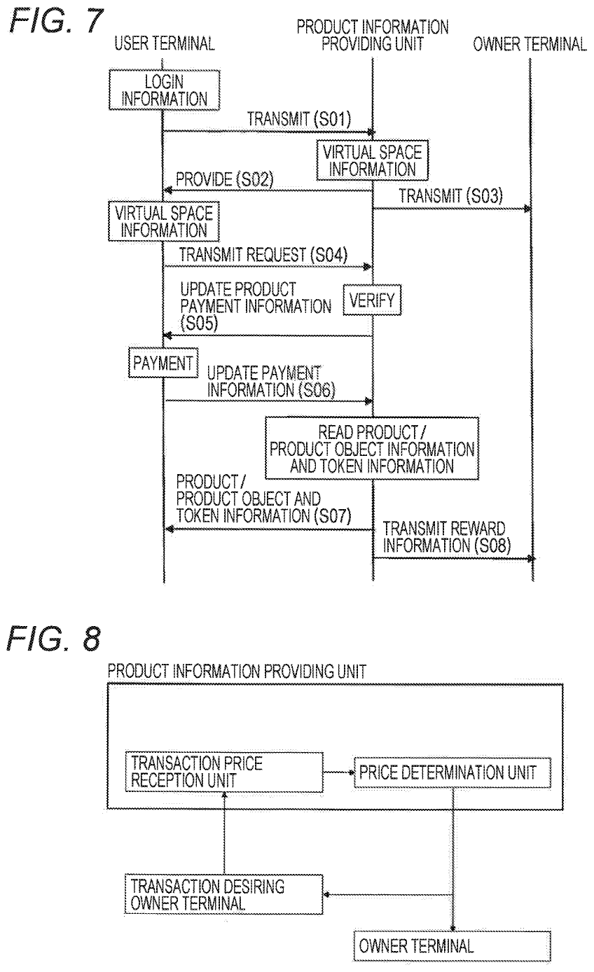

FIG. 7 shows the flow of the processing of the present system. As shown in the figure, the user transmits login information using the user terminal (S01), and logs in the service of the present system provided by the product experience providing device. The product experience providing device provides at least the user terminal with virtual space information (S02). The virtual space is displayed on the user terminal. The login information on the user is transmitted to the owner terminal associated with the product object requested by the user (S03).

When the user transmits a request for use, rental, or purchase of a product object owned by a certain owner (S04), the product experience providing device verifies request information transmitted from the user terminal. In the verification, for example, whether or not the position information transmitted from the user terminal is consistent with the information in the storage unit is verified using the server.

The product experience providing device transmits product payment information necessary for purchasing the object of the owner who owns the product object (S05). The user terminal performs the payment processing when purchasing the product object. When the payment processing is correctly performed, the payment information is transmitted (S06). The product experience providing device reads the purchased content information and token information corresponding thereto, and transmits the read information to the user terminal (S07). The payment processing may be performed by the user terminal or the product experience providing device, or may be performed using another payment business operator. The user can use the contents, and obtain a predetermined token corresponding to the contents. This flow can also be through a financial institution payment scheme. In this case, a financial institution serves as a substitute for the payment function of the user terminal.

The use of the product object may be performed by performing processing of changing the ownership of the contents from the owner to the user. Alternatively, only the product associated with the product object can be provided to the user. In this case, the change of the ownership may be certified by cooperating with another service capable of checking the ownership of the contents.

When the payment is completed, information for notifying that the product or the product object has been purchased may be transmitted to the owner terminal. At this time, a predetermined incentive can be paid to the owner (S08).

FIGS. 8 to 11 are diagrams showing configuration examples which can be implemented by addition to or partial replacement of the embodiment of the present invention. Since the product experience providing device shown in each figure includes a configuration similar to that of the product experience providing device described above, illustration of all the elements is omitted and detailed description thereof is omitted.

As shown in FIG. 8, the product information providing unit includes a transaction price reception unit and a price determination unit. A right related to the owner (owner) of the product and/or the product object may be traded. As shown in the figure, a transaction desiring owner terminal desiring the transaction makes a transaction request for the product experience providing device. At this time, a desired trade price (desired purchase price) is presented from a transaction desiring owner. The presented price is received by the transaction price reception unit. The price determination unit determines a price according to the received price request. The determined price is notified to the transaction desiring owner terminal and the current owner terminal. In this manner, the owner can obtain a profit by selling the structure object owned by the owner oneself to another person.

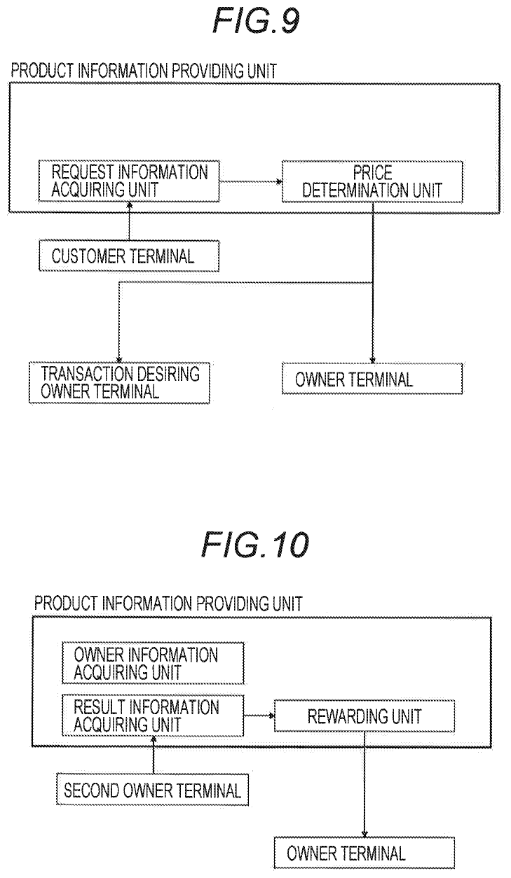

In the configuration example shown in FIG. 8, the price (value) of the product and/or the product object is determined based on the request from the transaction desiring owner terminal. However, as in the configuration example shown in FIG. 9, the price (value) of the product and/or the product object may be determined according to a result obtained from the product and/or the product object. As shown in the figure, the product experience providing device can also determine the price in response to a request from a transaction desiring user terminal. Alternatively, the transaction price may be determined in advance by the owner, and the processing may be performed so as not to respond to any transaction other than the transaction at this price. Specifically, the position information acquiring unit acquires the position information provided from a visiting user terminal of the user visiting each structure, and the price determination unit determines the price according to the number of visits. The determined price information is provided to the transaction desiring owner terminal and the current owner terminal.

With such a configuration, each owner can advertise, with the product object, the product owned by the owner oneself and/or the product corresponding to the product object, and the user can access the virtual space in which the product object that the owner desires to sell or transfer can be experienced. This can increase the value of the product and/or the product object. Furthermore, as described above, unique contents provided by the owner may be sold to the user who visits each product and/or product object. That is, the owner in the present embodiment can obtain a profit by selling the unique contents which cannot be obtained without visiting the structure. The owner can also obtain a profit by selling the product and/or product object of an increased value at a price greater than a purchase price. Each product and/or product object can increase the number of visitors to the virtual space where the access to the product and/or the product object can be made by the advertisement by the owner or the sale of the unique contents which cannot be obtained without visiting.

As an example of the method of determining the price, the price is determined based on the number of requests for the product object, which is calculated by visiting to the virtual space within a predetermined period, but the price may be calculated based on, for example, the number of users who have transmitted requests within a specific period, a user's purchase history of other products and/or product objects, and the like.

In the example described above, the product and/or the product object is owned by the owner, and the owner increases the value of the product and/or the product object by the advertisement or the like. However, for example, the right of use may be lent to a more influential owner (second owner). The second owner may advertise the product and/or the product object as an influencer who conveys the appeal of the structure, and receive a share of a predetermined level (not shown). As a result, it is possible to increase a revenue using the mechanism of the present invention while reducing cost and labor for the advertisement on the user. In addition, unique contents (second owner contents) provided by the second owner may be sold to the user. As shown in FIG. 10, the product information providing unit includes a result information acquiring unit that acquires a result based on the advertisement by the second owner and the sale of the second owner contents, and the rewarding unit that provides the owner terminal with a reward calculated according to the result as an incentive. An owner information acquiring unit of the product experience providing device manages and updates information on the owner and the second owner.

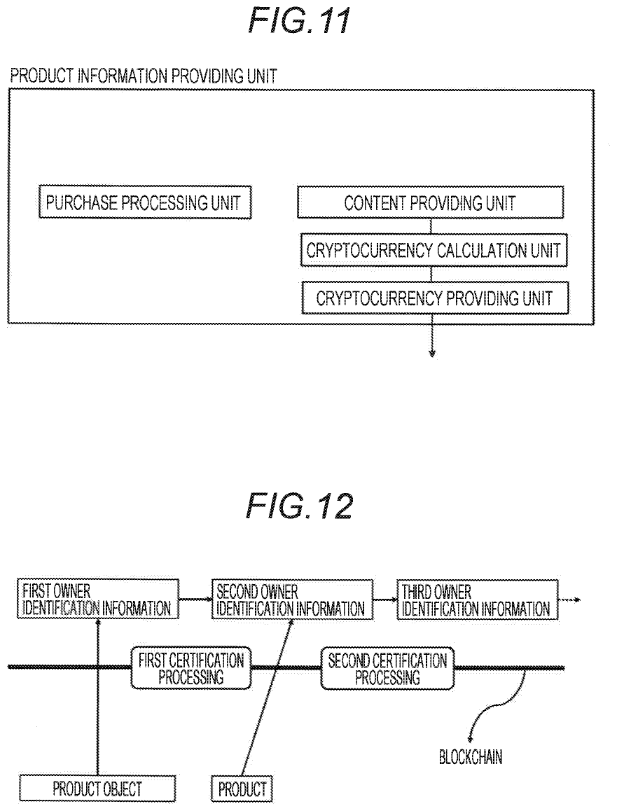

Next, as shown in FIG. 11, the product experience providing device includes a cryptocurrency calculation unit and the cryptocurrency providing unit. In a case where there is a purchase request related to the contents from the user terminal, the cryptocurrency calculation unit calculates the amount of cryptocurrency according to the contents. The cryptocurrency providing unit provides the calculated cryptocurrency such that the cryptocurrency is usable in the user terminal. The cryptocurrency may be a digital asset designed to act as an exchange medium. The record of the ownership of the cryptocurrency is released by the distributed ledger technology. The provided cryptocurrency may be, for example, a bitcoin or an alto coin, or may be one of which the value is fixed to the real currency, such as a stable coin. Furthermore, the cryptocurrency may be a token issued using an existing blockchain network. As long as the cryptocurrency has an economic value, the cryptocurrency may be of either a currency type or an asset type. As a result, it is possible to build an economic zone using the cryptocurrency. Note that the amount of provided cryptocurrency may be controlled according to the order or quantity of the contents purchased. This also makes it possible to create a structure for obtaining a predecessor benefit.

As shown in FIG. 12, in the structure object according to the present embodiment, the owner may be certified by the non-fungible token. As a result, it is also possible to cause a platform business operator providing a transaction service of the existing non-fungible token to cooperate and mediate the transaction processing. As shown in the figure, for the ownership of the structure object, a combination of the product and/or product object targeted for the transaction and first owner identification information (first owner wallet information) is certified on a blockchain network (certification processing 1). When the first owner sells the structure object to the second owner, it is certified that the ownership of the structure object is changed by certifying that the ownership of the structure object is transferred from the first owner identification information to second owner identification information (second owner wallet information) (certification processing 2).

The above-described embodiments are merely examples for the sake of easy understanding of the present invention, and are not intended to interpret the present invention in a limited manner. The present invention can be changed and modified without departing from the gist thereof, and it goes without saying that the present invention includes equivalents thereof.

It goes without saying that the invention examples described as the embodiments of the present application are not limited to those described in the present application, and can be applied to various examples within the scope of the technical idea. For example, in the embodiments of the present application, the system of each embodiment may be configured such that the information presented on the screen of the information processing device can be transmitted to the other information processing devices so as to be displayed on the screen of the other information processing devices.

The processing and procedures described in the present application may be achieved not only by those explicitly described in the embodiments but also by software, hardware, or a combination thereof. The processing and procedures described in the present application may be implemented as a computer program and executed by various computers. These computer programs may be stored in a storage medium. These programs may be stored in a non-transitory or temporary storage medium.

Although the modes for carrying out the present invention have been described above using the embodiments, the present invention is not limited to these embodiments, and various modifications and substitutions can be made without departing from the gist of the present invention.

1. A product experience providing device comprising:
a storage unit that stores a virtual space built on the Internet, a product object in the virtual space, which corresponds to a product present in a real space, product information associated with information (product object information) on the product object, and owner information approved as an owner of the product object and the product or any one of the product object or the product;
an object providing unit that provides the product object and a user object in the virtual space such that the product object and the user object are displayable on a display unit of a user terminal in the real space in association with the user terminal;
a product experience providing unit that provides the product object such that the product object is usable in a virtual space accessible by the user terminal in a case where a request related to the product object and the product or any one of the product object or the product is made from the user terminal in the real space; and
a product object rewarding unit that provides a predetermined reward to the owner of the product object and the product corresponding thereto according to a user's request from the user terminal within a predetermined period.

2. The product experience providing device according to claim 1, further comprising:
a product and product object price determination unit that
transacts a right related to the owner of the product object and the product or any one of the product object or the product on a predetermined transaction platform, and
in transaction, determines a transaction price of the product object and the product or any one of the product object or the product based on a price desired by the owner.

3. The product experience providing device according to claim 1, the right related to the owner of the product object and the product or any one of the product object or the product including information on a second owner to whom the owner lends the right, further comprising:
a share giving unit that gives, to the owner, part of an economic profit obtained by the second owner from the product object and the product or any one of the product object or the product.

4. The product experience providing device according to claim 1, further comprising:
a cryptocurrency providing unit that in a case where there is the request related to the product object and the product or any one of the product object or the product from the user terminal, provides a cryptocurrency corresponding to the product object and the product or any one of the product object or the product such that the cryptocurrency is usable in the user terminal.

5. The product experience providing device according to claim 4, wherein
the cryptocurrency is a token issued using a predetermined distributed ledger technology.

6. The product experience providing device according to claim 1, wherein
the owner of the product object and the product or any one of the product object or the product is certified by a non-fungible token, and
when the certified owner is changed, information is updated in the storage unit with the owner information and information on the product object and the product or any one of the product object or the product associated with information on the changed owner.

7. A product experience providing method comprising:
a step of acquiring, from a product experience providing device, a virtual space built on the Internet, a product object corresponding to a product present in a real space, product information associated with information (product object information) on the product object, and owner information approved as an owner of the product object and the product or any one of the product object or the product;
a step of displaying, on a display unit, the virtual space, the product object, and a user object according to a request from the user terminal;
a step of causing the product object to be usable by the user terminal in a case where a request related to the product object and the product or any one of the product object or the product is made from the user terminal in a real space; and
a step of providing a predetermined reward to the owner of the product object and the product corresponding thereto according to a request from the user terminal within a predetermined period.

8. A non-transitory computer-readable storage medium storing a product experience providing program for causing a computer to execute processing comprising:
a storage unit that stores a virtual space built on the Internet, a product object in the virtual space, which corresponds to a product present in a real space, product information associated with information (product object information) on the product object, and owner information approved as an owner of the product object and the product or any one of the product object or the product,
an object providing unit that provides the product object and a user object in the virtual space such that the product object and the user object are displayable on a display unit of a user terminal in the real space in association with the user terminal,
a product experience providing unit that provides the product object such that the product object is usable in a virtual space accessible by the user terminal in a case where a request related to the product object and the product or any one of the product object or the product is made from the user terminal in the real space, and
a product object rewarding unit that provides a predetermined reward to the owner of the product object and the product corresponding thereto according to a user's request from the user terminal within a predetermined period.

9. A product experience providing system comprising: a product experience providing device; and a user terminal, wherein
the product experience providing device includes
a storage unit that stores a virtual space built on the Internet, a product object in the virtual space, which corresponds to a product present in a real space, product information associated with information (product object information) on the product object, and owner information approved as an owner of the product object and the product or any one of the product object or the product,
an object providing unit that provides the product object and a user object in the virtual space such that the product object and the user object are displayable on a display unit of the user terminal in a real space in association with the user terminal,
a product experience providing unit that provides the product object such that the product object is usable in a virtual space accessible by the user terminal in a case where a request related to the product object and the product or any one of the product object or the product is made from the user terminal in the real space, and
a product object rewarding unit that provides a predetermined reward to the owner of the product object and the product corresponding thereto according to a user's request from the user terminal within a predetermined period, and
when the user terminal transmits the request related to the product object and the product or any one of the product object or the product to the product experience providing device in the real space, the product experience providing device provides the product object related to the request such that the product object are usable in the user terminal, and
the product experience providing device provides the predetermined reward to the owner of the product object and the product or any one of the product object or the product according to the request from the user terminal within the predetermined period.
